(19) United States
(12) Patent Application Publication
(10) Pub. No.: US 2015/0131304 A1
(43) Pub. Date: May 14, 2015

(54) Illuminated display ornament for automobiles

(71) Applicant: Michael D. Brown, San Diego, CA (US)

(72) Inventor: Michael D. Brown, San Diego, CA (US)

(21) Appl. No.: 14/078,382

(22) Filed: Nov. 12, 2013

(51) Int. Cl. B60Q 1/26; B60Q 1/32

(52) U.S. Cl. CPC B60Q 1/26; B60Q 1/323
USPC 362/501; 362/487

(57) ABSTRACT

It is an object of the present invention to provide a novel illumination system and methods that can be used on the outside of an automobile. The illumination system may preferably be displayed on the outside of a door panel of an automobile, but may also be displayed on any other exterior surface of an automobile. The illuminated design may employ fiber optic cables to illuminate the preferred design.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF INVENTION

1. Field of the Invention

The present application relates to the field of automotive ornamental display and methods of accomplishing same.

2. Background of the Invention

Emblems, logos, and other ornamental displays are frequently displayed on the outside of motor vehicles. Sometimes, such ornamental displays are an expression of the automobile owner's enthusiasm or support of the subject matter presented in the display. Consider that: some drivers enjoy expressing a motto to cheer up other motorists; other drivers enjoy displaying loyalty to a school, sports team, or political affiliation; and, some drivers simply just seek to draw attention to their vehicles. Car window stickers, customizable license plates, and slogans printed on mud flaps are just a few examples of individual expression on the exterior of automobiles.

Illuminated automobile ornamental displays have also existed for a long time. Colored light emitting diode (LED) light displayed underneath a car is one example of attracting attention to an automobile using illuminated displays. Other uses of light sources have allowed automobile enthusiasts to shine light on logos or emblems painted or adhered to the side of an automobile. For instance, U.S. Patent Publication No. US20120313392 by Bingle discloses illuminated visual markers on automobiles by shining light through a light-transmissive substrate. While capable of displaying illuminated emblems or logos on cars, the illumination system described by Bingle is limited in automobile applications because many car parts, like door panels, cannot easily or practically be constructed of transmissive materials. As a consequence, the Bingle system has typically been limited to car trim components. Accordingly, a need exists for illumination systems that can be displayed at any location on a vehicle's exterior, and especially central to vehicle panels.

Illumination systems also exist outside of automobile applications. For instance, U.S. Pat. No. 6,234,657 by Shih discloses a decorative panel with a cluster of coterminous fiber optic cables that are illuminated with a light source. Further, U.S. Pat. No. 7,131,761 by Pipo, et al, discloses a solid pattern with optical fibers terminating on the surface of the solid part to display an illuminated image. While these systems are useful for presenting illuminated images, the systems of Shih and Pipo do not have automotive applications because the same are not weatherproof. Thus, these illumination systems do not provide a solution to the above identified need.

### SUMMARY OF THE INVENTION

In view of the foregoing, it is an object of the present invention to provide a novel illumination design that can be used on the outside of an automobile. The illumination design may preferably be displayed on the outside of a door panel of an automobile, but may also be displayed on any other exterior surface of an automobile.

It is a further object of the present invention to provide a novel illumination design utilizing a light source to illuminate flexible fiber optic cable. The illuminated fiber optic cables can be routed into fixed positions within a sign to trace letters, numbers, figures or graphics.

It is a further object of the present invention to provide a novel illuminated design that can be seen at a considerable distance away, and yet may not be obtrusive to drivers passing in either direction of the vehicle. In some embodiments, it is an object of the present invention to illuminate a display sufficiently at night.

### BRIEF DESCRIPTION OF THE FIGURES

The manner in which these objectives and other desirable characteristics can be obtained is explained in the following description and attached figures in which:

FIG. 1 is an environmental view of a preferable embodiment of the invention depicting the illuminated design through a panel.

FIG. 2A is an environmental view of a preferable embodiment of the invention depicting the back side of the panel.

FIG. 2B is an environmental view of a preferable embodiment of the invention depicting the back side of the panel.

FIG. 3 is an environmental view of a preferable embodiment of the invention depicting the light source and the panel.

FIG. 4 is an environmental view of the preferable embodiment of the invention depicting the light source and circuit board.

FIG. 5 is an environmental view of the preferable embodiment of the invention depicting the fiber optic cables.

### DETAILED DESCRIPTION OF THE INVENTION

An illuminated display ornament for automobiles is described. In the following exemplary description numerous details are set forth to provide a more thorough understanding of the ideas described throughout this specification. It will be apparent, however, to an artisan of ordinary skill that embodiments of ideas described herein may be practiced without incorporating all aspects of the specific details. In other instances, specific aspects well known to those of ordinary skill in the art have not been described in detail so as not to obscure the broadest disclosure. Readers should note that although examples of the innovative concepts are set forth throughout this disclosure, the claims, and the full scope of any equivalents, are what define the invention.

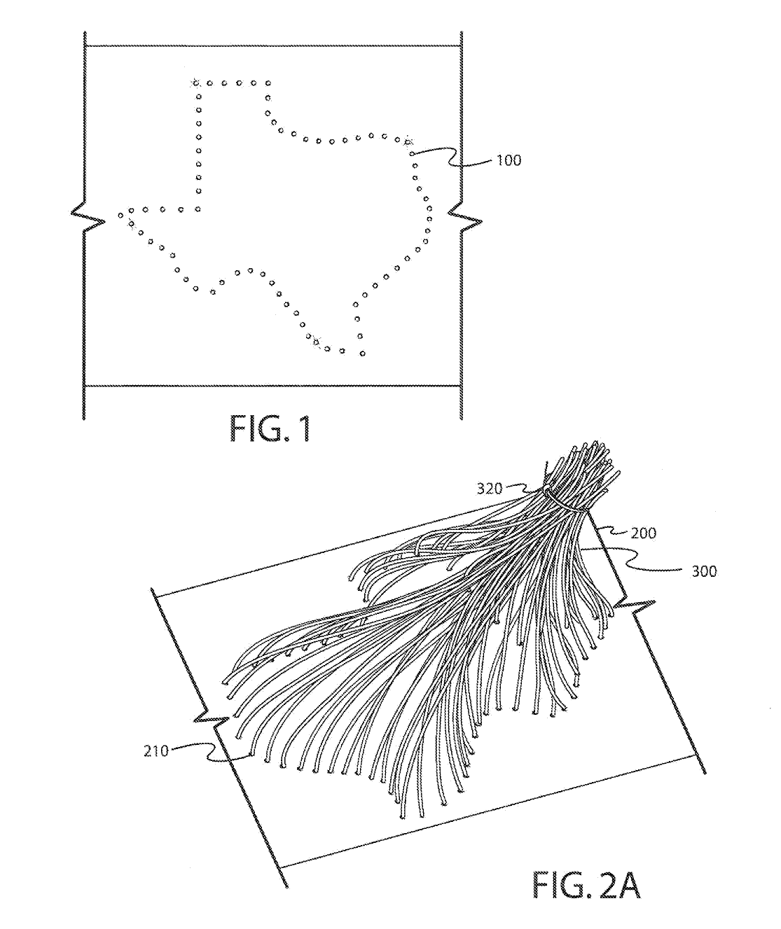

FIG. 1 depicts a preferable embodiment of the invention in which the embodiment displays an illuminated pictoral representation of the state of Texas within an automo bile door panel. I n this particular embodiment, the illuminated display 100 utilizes fiber optic cables (not shown) routed to specific points of the door panel. The fiber optic cables are illuminated by a light source connected to the cables behind the door panel and the internal electrical wiring of the vehicle. In some embodiments, the light source(s) are light emitting diodes (LEDs).

Still referring to FIG. 1, the illuminated design 100 may be any alphabetic, numeric, symbolic, or pictorial design. Logo designs may be a preferable design for enthusiasts of particular sports teams, educational institutions, corporate entities, geographic regions, or other such groups. The illuminated design 100 may feature lights of varying colors. Furthermore, the illuminated design 100 may feature colors pertaining specifically to the colors of a recognized emblem, logo, picture, or symbol.

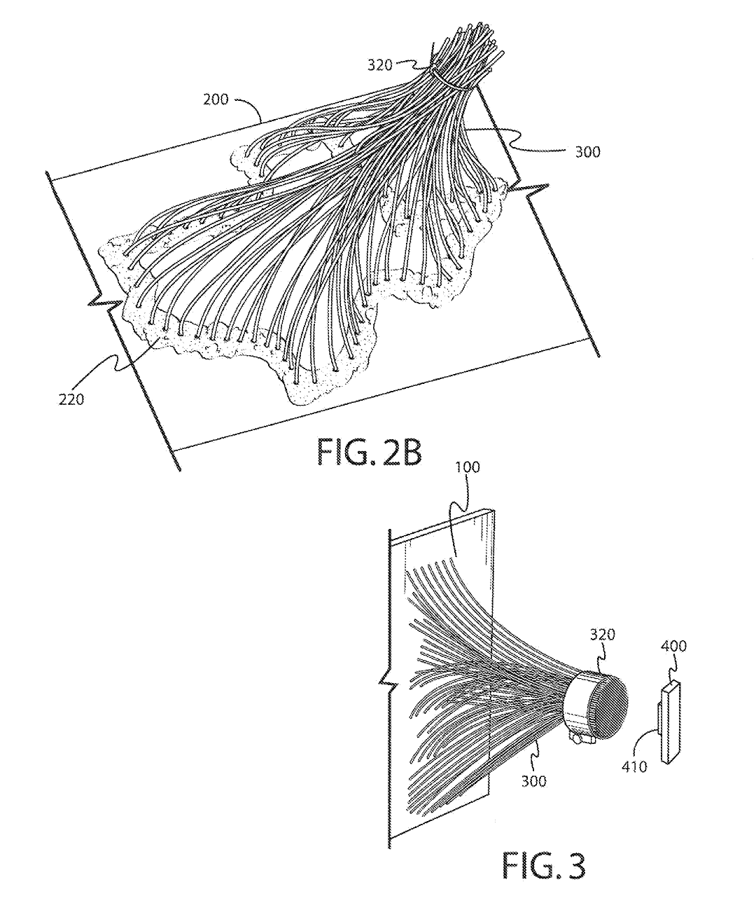

FIG. 2A depicts the back of a panel 200 installed with a preferable embodiment of the invention. In this particular embodiment, the panel 200 is an automobile door panel. As shown in the figure, fiber optic cables 300 are affixed to the back the panel 200 and placed in positions according to a predetermined design as described above. Before the fiber optic cables 300 are installed, holes 210 are drilled into the panel. The holes 210 are drilled according to an outline of the particular design. In some embodiments, the holes 210 are 3/64 inch in diameter. In other embodiments, the holes 210 vary from 1/32 inch to 1 inch in diameter. Once the holes 210 are drilled, the fiber optic cables 300 are inserted to approximately ½ inch beyond the outside of the panel 200. In some embodiments, the fiber optic cables 300 are inserted more than ½ inch outside the panel 200. In other embodiments, the fiber optic cables 300 are not inserted past the outside of the panel 200.

FIG. 2B depicts the configuration represented in FIG. 2A but with the fiber optic cables 300 fastened to the panel 200. After the fiber optic cables 300 are placed in position, the fiber optic cables 300 are fixed to the panel 200. The fiber optic cables 300 may be affixed to the panel 200 by gluing, taping, welding, or by other means of fastening. In some embodiments, the fiber optic cables 300 are attached to the panel 200 by insulating foam sealant 220. The foam sealant 220 provides strong protection to the cables 300 from environmental concerns including, but not limited to: air leakage, thermal expansion or contraction, vibration, sound insulation, condensation, and precipitation.

FIG. 3 depicts an embodiment of the illuminated display 100 shoving the configuration of the fiber optic cables 300 relative to a light source 410. The light source 410 may be connected to and located on a circuit board 400. In some embodiments, the light source 410 is formed with light emitting diodes (LEDs). As shown in the figure, the fiber optic cables 300 are cut and bundled together at the end. In some instances, the end of the cut fiber optic cables are bundled together with a plastic tie rod 320 or some other equivalent bundling means. Furthermore, this end of the fiber optic cables 300 should be cut evenly. An even cut will ensure better light distribution from the light source 410. The cut end may then be placed in front of the light source 410 as shown. In some embodiments, the cut end of the fiber optic cables 300 will be located approximately one inch from the light source 410. In other embodiments, the cut end of the fiber optic cables 300 will be located ½ inch, ¾ inch, or between 1 to 2 inches away from the light source 410.

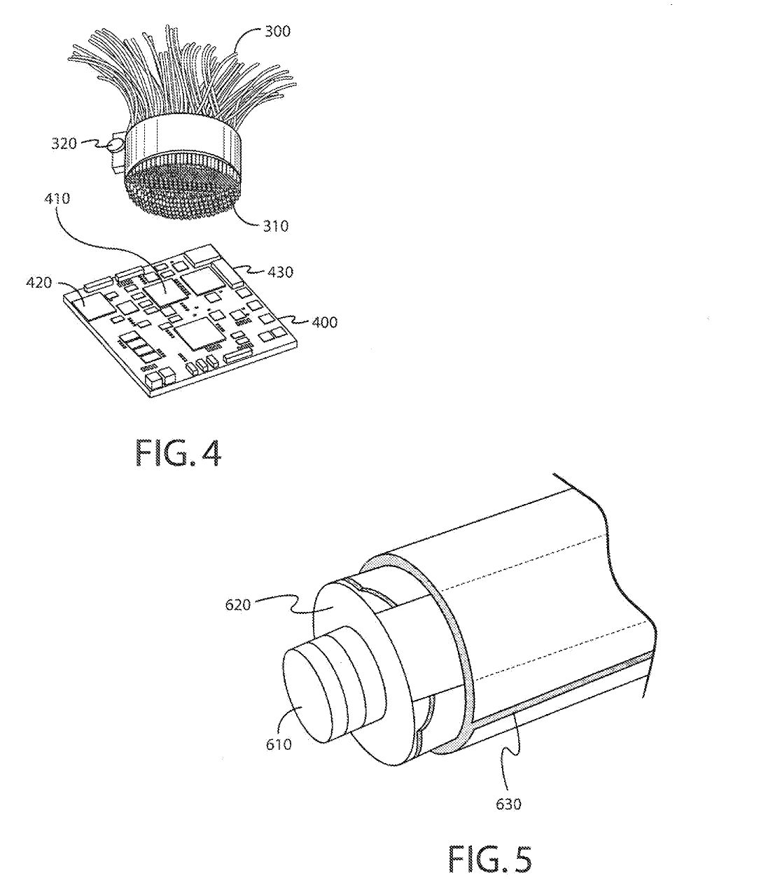

FIG. 4 depicts a close view of the fiber optic cables 300, light source 410, and circuit board 400. The circuit board 400 may comprise a light source 410, a resistor 420, and a switch 430. In some embodiments, the light source 410 may be connected to the resistor 420 by an electrical wire or connection. The resistor 420 in some embodiments may be a 560 Ohm (Ω) resistor. The resistance of the resistor 420 may depend on the brightness of the LED or the color of the LED. The switch 430 may be connected to the resistor 420 by electrical wire or other connective means. In some embodiments, the electrical wire is a 20 gauge electrical wire. In some embodiments, the switch 430 is one of the following types of switches: ON/OFF switch, bias switch, push-button switch, rotary switch, toggle switch, trembler switch, limit switch, magnetic switch, pressure switch, sad switch, frit switch, knife switch, foot switch, reverse switch, or wireless switch.

In some embodiments, the switch 430 is connected to the car battery (12V power source). The power source will charge the LED (not shown). In some embod it ents, the switch 430 is located near the driver's seat in an automobile (not shown). This allows the driver to easily reach for the switch 430 and turn on or off t he illuminated display 100. In such embodiments, the switch 430 may be located on the light source circuit 400 board, or may be located away from the board. If the switch 430 is located away from the circuit board 400, the switch 430 will be able to communicate with the board either wirelessly or hardwired.

In some embodiments, the design to be displayed is selected from a database. A user will select a particular design, symbol, or logo from a collection of designs within a database, preferably located in a computer. The computer will generate a stencil outline based on the selected design. The computer may be connected to a three dimensional printer used to generate the stencil outline. The user may place the stencil outline onto a panel, such as a car door panel, and use the stencil to guide the user in drilling holes in which form the outline of the selected design.

FIG. 5 depicts a close up view of a preferred embodiment of the fiber optic cable. The fiber optic cable may consist of a core 610 and a cladding layer 620, selected for total internal reflection due to the difference in the refractive index between the two. The cladding 620 is usually coated with a layer of acrylate polymer or polyimide. This coating protects the fiber from damage but does not contribute to its optical waveguide properties. Individual coated fibers (or fibers formed into ribbons or bundles) then have a tough resin buffer layer 630 and/or core tube(s) extruded around them to form the cable core 610. Several layers of protective sheathing, depending on the application, are added to form the cable. Some embodiments will employ more rigid fiber assemblies, which involve light-absorbing glass between the fibers to prevent light that leaks out of one fiber from entering another. This reduces cross-talk between the fibers, or reduces flare in fiber bundle imaging applications. Due to the fact that the fiber optic cables will be employed outdoors, some embodiments of the invention will surround the fibers with solid barriers such as copper tubes, water-repellant jelly, or water-absorbing powder.

While the ideas herein disclosed has been described by means of specific embodiments and applications thereof, numerous modifications and variations could be made thereto by those skilled in the art without departing from the scope of the invention set forth in the claims.

The invention claimed is:

1. An illumination system for vehicle panels comprising:
a plurality of fiber optic cables;
a light source to illuminate the fiber optic cables;
a circuit board electrically coupled to and directing the light source;
a power source to power the light source; and,
wherein said fiber optic cables are inserted into an automobile panel in an outline forming a pre-determined design.

2. The illumination system of claim 1, wherein the automobile panel is an automobile door panel.

3. The illumination system of claim 1, wherein the pre-determined design is numeric, letter-based, alphanumeric, or pictorial.

4. The illumination system of claim 1, wherein the power source is an automobile battery.

5. The illumination system of claim 1, wherein the fiber optic cables are inserted ½ inch past the exterior of the automobile panel.

6. The illumination system of claim 1, further comprising a switch to turn on or off the illuminated design.

7. The illumination system of claim 6, wherein the switch is located near the driver's side of an automobile.

8. The illumination system of claim 1, wherein the fiber optic cables are attached to the automobile panel with foam sealant.

9. The illumination system of claim 1, wherein the fiber optic cables further comprise solid barriers surrounding the fibers to counter environmental factors.

10. The illumination system of claim 1, wherein the solid barriers are copper tubes, water-repellant jelly, or water-absorbing powder.

11. The illumination system of claim 1, further comprising a resistor electrically coupled to the circuit board, possessing a resistance of 560 Ohms.

12. The illumination system of claim 1, wherein the pre-determined design is formed via a stencil.

13. A method of displaying an illuminated design on an automobile panel comprising:
selecting a pre-determined design for display on the exterior of an automobile from a database;
forming holes into the automobile panel according to the outline of the design;
providing a plurality of fiber optic cables, wherein said fiber optic cables are inserted into an automobile panel in an outline forming a pre-determined design;
providing a light source to illuminate the fiber optic cables; and
providing power to the light source.

14. The method of claim 13, wherein t he database is located in a computerized system which is connected to a display for viewing and selection of the design.

15. The method of claim 14, wherein the computerized system is connected to a three-dimensional printer which prints out a stencil after selection of the design.

16. The method of claim 13, wherein said fiber optic cables are inserted through the automobile panel up to ½ inch past the exterior of the automobile panel.

17. The method of claim 3, wherein the power is provided by an automobile battery.

18. The method of claim 13, wherein the fiber optic cables further comprise barriers surrounding the fibers.

19. method of claim 18, wherein the barriers are copper tubes, water-repellant jelly, or water-absorbing powder.

20. The method of claim 13, wherein the fiber optic cables are attached to the automobile panel with foam sealant.
